(19) United States
(12) Patent Application Publication
(10) Pub. No.: US 2012/0001918 A1
(43) Pub. Date: Jan. 5, 2012

(54) Techniques for Displaying Numeric Data Sets that Include Multiple Measures

(76) Inventors: Sivanandan Sankaraswami, Bangalore (IN); Praveen Kumar Padegal, Adoni (IN); Naveen Kumar, Varanasi (IN); Avinash Venkateshaiah, Bangalore (IN)

(21) Appl. No.: 12/828,654

(22) Filed: Jul. 1, 2010

(51) Int. Cl. G06T 11/20

(52) U.S. Cl. 345/440

(57) ABSTRACT

Various embodiments of computer implemented techniques, methods, computer executable instructions, and systems for displaying data are described herein. Various embodiments include methods such as a method including receiving data including a dimension and a set of measures. The set of measures includes a first measure, a second measure, and a third measure. The method also includes associating the dimension with a set of markers. The first measure is associated with a first axis and the second measure with the area of the markers. The third measure is associated with a set of indicators. The indicators are embedded in a plurality of the set of markers. The method further includes displaying the set of markers with respect to the first axis in a graph.

### FIELD

The present teachings relate to visualization of data. More precisely, the teachings relate to displaying a greater number of measures of data than are physical dimensions in a display.

### BACKGROUND

In business, governance, research, and other activities much numeric data is collected. Data is visualized using techniques such as tables, maps, word clouds, and graphs. Graphs are a commonly used visualization. There are many known types of graphs. These have different features including differing capacities to display measures and dimensions, also known as dependent and independent variables.

A scatter plot is a type of graph using Cartesian coordinates to display values. Its creation has been attributed to William Herschel in 1832. At that time the plot consisted mainly of a set of dots or markings on graph paper where an axis could be a dimension or a measure. Now a scatter plot is generally regarded to mean a visualization plotting one dimension against two measures. The two axes are associated with the measures and the markings correspond to members of the dimension. As such, a scatter plot is for discrete dimensions. This kind of plot is also called a scatter chart, scatter diagram, scatter graph, two-dimensional histogram, or co-occurrence matrix.

There are variations of the scatter plot. Some display three measures against one dimension. For example, a scatter plot can be rendered over a three dimensional Cartesian coordinate system. A bubble plot is a scatter plot where the set of dot markings is replaced with a set of bubbles whose area is proportional to a third measure. Colour, shading, or symbols may be use to support multiple dimensions in bubble or scatter plots. A scatter plot matrix comprises an array of plots, each plot showing the dimension's correlation with respect to a pair of measures. The array continues until all measures are paired. Animation can be used to show the progression of bubbles in a bubble plot and thereby adding a dimension, such as time.

### SUMMARY

Various embodiments of computer implemented techniques, methods, computer executable instructions, and systems for displaying data are described herein. Various embodiments include methods such as a method including receiving data, including a dimension and a set of measures. The set of measures includes a first measure, a second measure, and a third measure. The method also includes associating the dimension with a set of markers. The first measure is associated with a first axis and the second measure with the area of the markers. The third measure is associated with a set of indicators. The indicators are embedded in a set of markers. The method further includes displaying the set of markers with respect to the first axis in a graph.

Various embodiments include computer executable instructions such as a computer readable medium comprising computer readable instructions, which, when executed by a computer, cause the computer to perform a method. The method includes displaying a data set within a graph. The graph comprises a set of markers arranged with respect to a first axis and a second axis. The set of markers are associated with a dimension in the data set, and arranged with respect to the first axis according to values associated with a first measure. The set of markers are also arranged with respect to the second axis according to a second measure in the data set, and scaled in size with respect to a third measure in the data set. Each maker is augmented with an indicator representing values of a fourth measure. The method includes receiving a user interaction selecting a subset of markers. The display is updated to show the subset of markers in uniform scale.

Various embodiments include computer executable instructions such as a computer readable medium comprising computer readable instructions, which, when executed by a computer, cause the computer to perform a method. The method includes receiving data that includes a dimension, a set of measures including a first measure, a second measure, and a third measure. The dimension is associated with a set of markers. The first measure is associated with a first axis and the second measure is associated with the area of the markers. The third measure is associated with a set of indicators. The indicators are embedded in a set of markers. The graph is returned.

The benefits and features of the present teachings will be apparent upon consideration of the following detailed description of preferred embodiments thereof, presented in connection with the following drawings.

### BRIEF DESCRIPTION OF THE DRAWINGS

The present teachings are illustrated by way of example and not by way of limitation in the figures of the accompanying drawings in which like references indicate similar elements. The present teachings, together with various embodiments, may be best understood from the following detailed description taken in conjunction with the accompanying drawings. In the drawings:

FIG. 1 is a flow diagram of a method for preparing and rendering visualizations.

FIG. 2 is an example of a visualization including one dimension and four measures using gauges within the bubbles.

FIG. 3 is a variation of the visualization in FIG. 2 including one dimension and three measures and a different scale for the gauges.

FIG. 4 is an example of a visualization including two dimensions and four measures.

FIG. 5 is an example of the visualization including a plurality of markers shown as the same size for comparison purposes.

FIG. 6 is a flow diagram of a method for rendering visualizations.

FIG. 7 is a table showing criteria for preparing and rendering visualizations.

FIG. 8 is a block diagram of a system for defining, rendering, or displaying visualizations.

### DETAILED DESCRIPTION

Embodiments of techniques for creating visualizations for data are described herein. In the following description, numerous specific details are set forth to provide a thorough understanding of the present teachings. It is understood one skilled in the relevant art will recognize that the various embodiments can be practiced without one or more of the specific details, with different combinations of specific details, or with other methods, components, materials, etc. Well-known structures, materials, or operations are not shown or described in detail to avoid obscuring aspects of the present teachings.

It is understood that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment. Furthermore, the particular features, structures, or characteristics may be combined in any suitable manner in one or more embodiments.

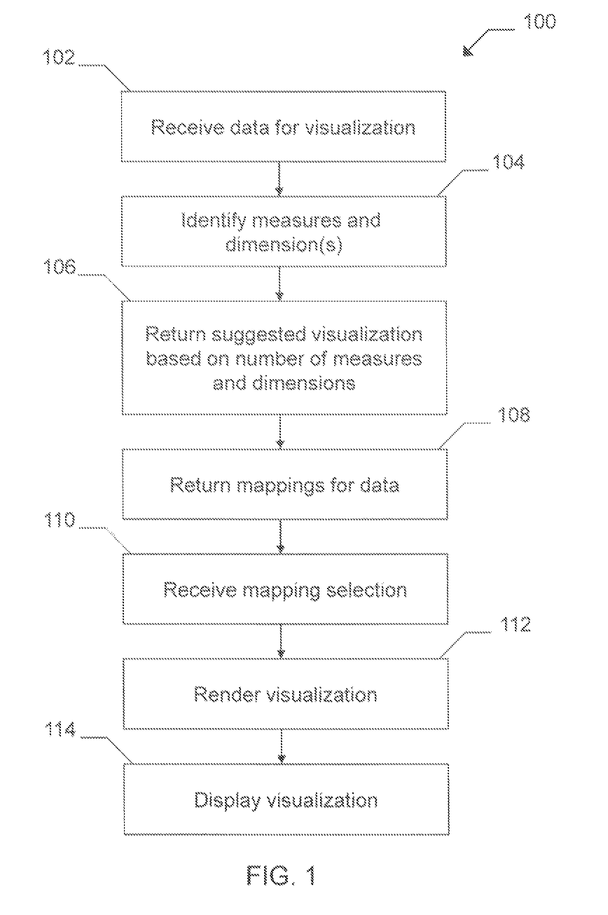

FIG. 1 shows a flow diagram of a method 100 for preparing and rendering a visualization in accordance with various embodiments. To create graphs data is needed. The data for the operation is received at operation 102. The data can be machine or human readable, in structured form, e.g., returned from a database query, or semi-structured form, e.g., XML. The data is, at least in part, numeric. Next, the measures and dimensions within the data are identified, 104. That is one or more portions of the data are classified as one or more measures and another portion, or other portions, are classified as a dimension, or dimensions. The variables in the data can be classified in at least two different ways: independent versus dependent, and parametric versus categorical. An independent variable is a quantity or category that is subject to choice or manipulation by an investigator. An investigator is a person involved in the collection and review of data. Examples of independent variables are time, product, species, and country. A dependent variable is a measured property that varies as an associated independent variable is changed. Examples include count, revenue, profit, mass, length, and the like. A parametric variable has a numeric value. It may be continuous, like length and time, or discrete, like a population count. It can be operated upon by arithmetic, logical, relational, and other operators. A categorical variable, like species or country, represent distinct members, with no intermediates. That is the values of the variable are discrete. Generally, arithmetic operators can't be used with them but relational and logical ones can. In some embodiments a measure is a parametric dependent variable. In other embodiments a measure is a dependent variable. Techniques exist for distinguishing, measures from dimension based on the definitions for these variables. As well, in various embodiments, the data can be associated with metadata specifying the measures, dimensions, categorical data, parametric data, as well as other information, such as language, unit, and the like.

Operation 106 includes returning one or more options for a visualization based on the number or measures and dimensions. For example, a scatter plot would be an option if two measures and one dimension were present. It is an option because a scatter plot is for two measures and one dimension. The one or more options can be returned to a user, or requesting application. The options may be displayed for a user. In various embodiments, the options are ranked. One or more mappings of the data to the axes of the visualization are returned 108. An axis for the purposes of mapping is an attribute of a visualization such as a Cartesian dimension, an arrangement of segments in a pie chart or stacked bar chart, input that leads to the variation of length, angle, area, volume or shading of a part of visualization or selection of marker type or colour for the visualization and the like. The mappings can be ranked. Receive the choice of visualization or and mappings, or apply one or more defaults (operation 110). The visualization is rendered (operation 112). In various embodiments, rendering includes computing the arrangement of the components of the visualization. For example, rendering can include computing the coordinates and sizes of the markers. In various embodiments, the visualization is returned (operation 114). The visualization can be stored but can also be displayed to a user.

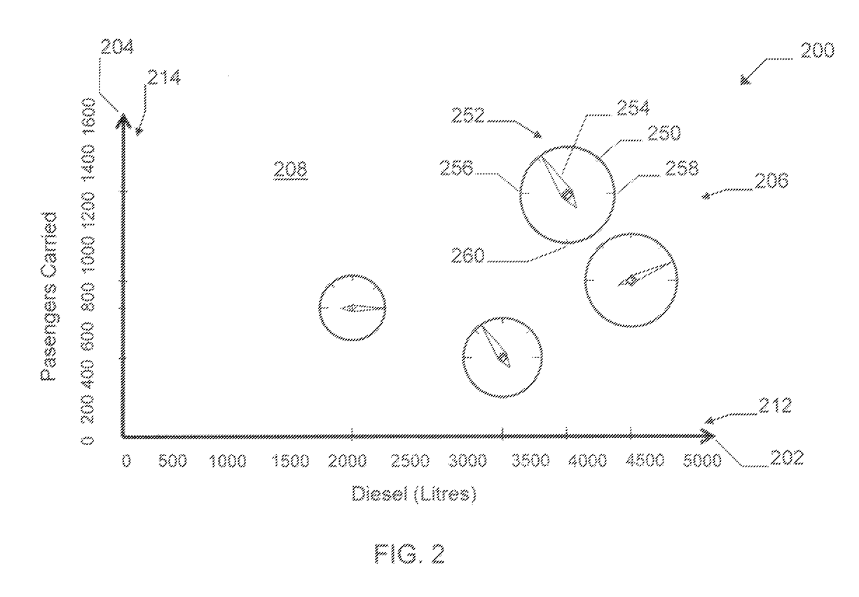

FIG. 2 is an example of visualization 200 including one dimension and four measures. The visualization 200 can appear in a display, on the printed page or the like. The visualization includes an x-axis 202, a y-axis 204, and a set of markers 206, arranged around or on a canvas 208. A first measure is assigned to the x-axis. The instant values are shown as tick marks 212 used in this and some other embodiments. A second measure is assigned to the y-axis. The instant values are represented by a set of tick marks 214. A third measure is assigned to the area of the markers. The markers in the set of markers have a one-to-one correspondence with a dimension—that is, a categorical independent variable or independent variable. Each marker in the set of markers 206 include an indicator for a fourth measure. The indicators in the shown set of markers 206 are gauges.

Marker 250 is a representative marker in the set 206. Marker 250 includes an optional scale 252 for a gauge within the marker. The marker includes a needle 254 that pivots around a central point. The needle can swing from a minimum point 256 on the scale 252 to a maximum point 258. In the embodiment shown, the scale 252 follows a convention where the minimum is the east cardinal direction or the negative x-axis if a Cartesian grid were imposed on the marker 250. In the embodiment shown, the maximum point 258 is at 180 degrees away from the minimum point 256 and the range is over the top half of the marker. In some embodiments, the location of the minimum, maximum or range is different. In various embodiments the minimum mark 256 aligns with a corresponding highlighted tick mark on the y-axis 204. In various embodiments, a sight to axis 202 can be placed on the markers. A sight is a marking to help the viewer more precisely locate the center of the marker on a Cartesian axis like axis 202. An example of such a sight is sight 260 on marker 250. The data in the visualization 200 is drawn from

TABLE 1
It is a fictional bus company with four divisions.

| Bus Division | Diesel (L) | Profit ($) | No of Buses | No of Passengers |
|---|---|---|---|---|
| North | 2,012 | 62,267 | 20 | 673 |
| East | 3,884 | 56,002 | 39 | 1,289 |
| South & West | 4,410 | 22,401 | 44 | 809 |
| Central | 3,103 | 21,001 | 33 | 412 |

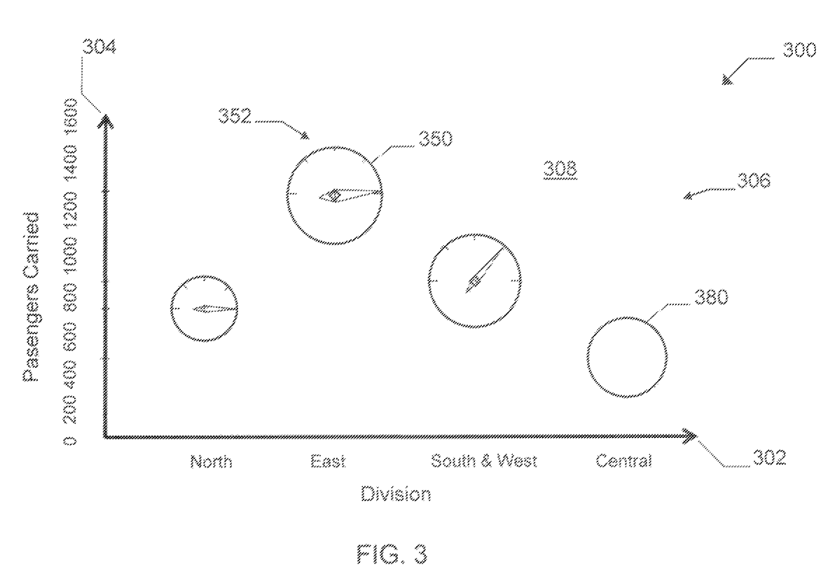

FIG. 3 is a variation of the visualization in FIG. 2. The visualization 300 includes one dimension and three measures. As well, there is a different scale for the gauges. Further, one measure is incomplete over the dimension. That is one or more markers lack an indicator. The similarities with visualization 200 are apparent. The visualization 300 includes an x-axis 302, a y-axis 304, a set of markers 306, canvas 308, and the like. Similar to FIG. 2, a first measure is assigned to the y-axis. A second measure is assigned to the area of the markers. The area of the marker is proportional to the instant value of the measure for the corresponding member of the dimension. A third measure is assigned to the indicators embedded in a plurality of the set of marker 306. This plurality can be all or a sub-set of the set of markers 306. In contrast to FIG. 2, the x-axis 302 is assigned the same dimension as the markers 306. Marker 350 is a first representative marker in the set 306. The visualization 300 is useful when the data set include degeneracy in one or more measures. This is where one or more measures associated with the Cartesian dimensions have like values, or near like values, such that the bubbles overlap. In various embodiments near like is determined by the size of the bubbles. Visualization 300 does not suffer from this as the centers of the markers 306 are separated. The scale 352 is trigonometric, mapping the real range to a minimum value and a maximum value. In various embodiments the scale is logarithmic. Marker 380 is a second representative marker in the set 306. The marker 380 includes no gauge because the third measure for the data set is incomplete. That is the value of the third measure for the member of the dimension associated with marker 380. “Central”, has a null or not a number (NAN) value. The gauge is the appropriate axis for such a measure since omission of a data value is not something that can be unambiguously displayed on the x-axis, y-axis or area of the markers.

It is understood that different terms can be used to describe visualizations and data. Herein reference is made to dimensions, measures, axes, and Cartesian dimensions. Respective alternative terms include independent variables, dependent variables, visualization dimensions, and dimensions. In such language a scatter plot has two dimensions (that is x and y), two axes, two dependent variables and one independent variable. The visualization is said to have two axes or even two dimensions. A bubble plot in this terminology has three axes or three dimensions. The visualization of FIG. 2 has four axes or dimensions. The visualization of FIG. 3 would be said to have four axes or dimensions too. Another respective alternative set of terms is categorical dimensions and parametric dimensions in place of dimensions and measures. A measure can be called a numeric dimension too.

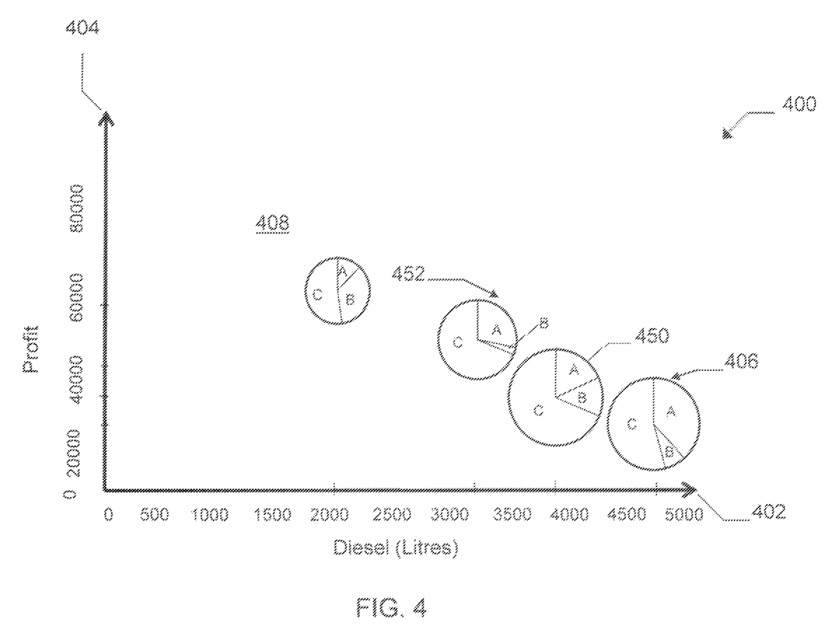

FIG. 4 is an example of a visualization 400 including two dimensions and four measures. The visualization includes an x-axis 402, a y-axis 404, a set of markers 406, arranged around or on a canvas 408. A first dimension is mapped to the set of markers 406. The markers are positioned with respect to the x-axis 402 according to the value of the first measure for each member of the dimension. The same is done for the y-axis and the second measure. A third measure is assigned to the area of the markers 406. The set of markers 406 include an indicator for a fourth measure. Markers 406 include pie charts showing how each member of a second dimension contribute to the whole, or total value, for a fourth measure.

Marker 450 is a representative marker in the set 406. Marker 450 includes a set of pie segments 452. Each pie segment 452 shows the contribution of a member of a second dimension to a whole measure. A pie chart is a circle divided into segments 452. Each segment is for each member of a dimension. identified as the break-down dimension. Each segment 452 illustrates a percentage of a whole. The angle of each segment and thus its area is proportional to the measure it represents. Together, the segments create a full circle. The data in the visualization 400 is drawn from Table 2. It has the breakdown of ticket classes (A, B, and C) for the total number of passengers.

| Bus Division | A | B | C | Profit($) |
|---|---|---|---|---|
| North | 89 | 64 | 520 | 62,267 |
| East | 232 | 174 | 883 | 56,002 |
| South & West | 311 | 60 | 438 | 22,401 |
| Central | 117 | 11 | 284 | 21,001 |

In some embodiments, the breakdown dimension for each marker in the set of markers 406 need not be the same. They can differ by one or more members. The fourth measure includes a total value for all members of the dimension. This total can be calculated or be part of the measure. The mapping of measures and dimensions to axes of a visualization can identify which dimension and associated measure is suitable for including as pie chart indicators in a visualization, such as visualization 400.

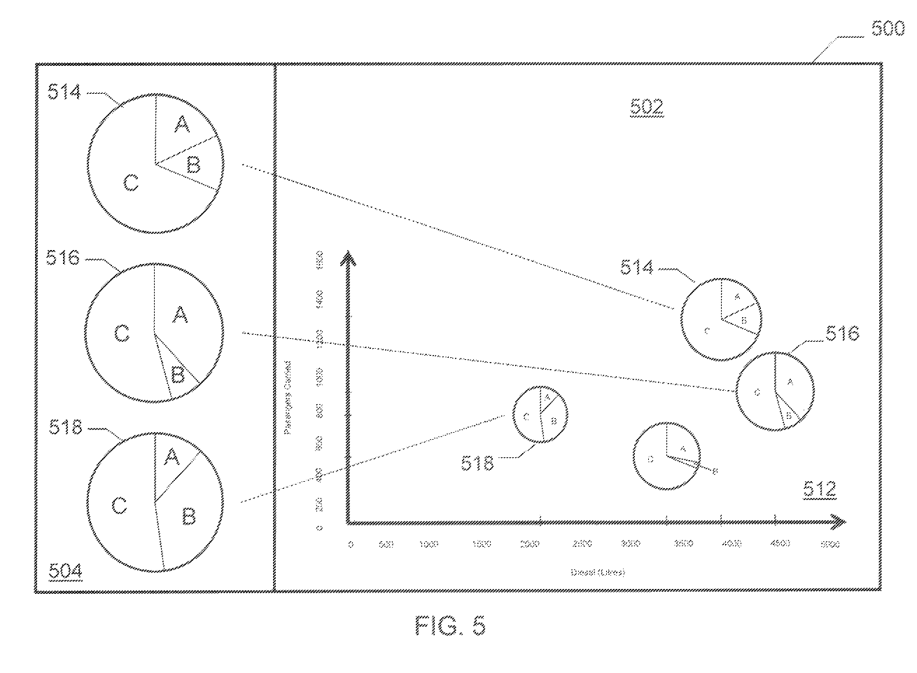

FIG. 5 is an example of the visualization including a plurality of markers shown as the same size for comparison purposes. FIG. 5 includes visualization 500 which has a first region 502 and a second region 504. The first region 502 includes the visualization. The second region 504 includes selected markers each shown at a uniform scale. In some embodiments, a user can select two or more markers to be rendered at the same scales for comparison purposes. The user makes a selection of two or more markers in a display of a visualization such as visualization 512. For example, selecting markers 514, 516 and 518. The user provides input indicating that a comparison view is desired. For example, right-click on a group selection and choose from a pop-up menu. This selection procedure can be implemented following an interaction pattern for implementing “brushing” in scatter plots. Brushing is the selection of certain Markers to highlight them. Brushing is often used in scatter plot matrices. The first region 502 includes the visualization 502. The second region 504 includes selected markers 514, 516 and 518 each zoomed to a uniform scale. A zoom corresponds to enlargement or reduction to the same scale. In some embodiments, the selected markers 514, 516 and 518 are shown with legends, titles and/or other annotations. In some embodiments, the selected markers 514, 516 and 518 are shown next to the visualization they were selected from, for example, visualization 512. In some embodiments, this visualization includes highlighting on each of the selected markers. In some embodiments, the selected markers 514, 516 and 518 aren't the original bubbles with their embedded indicators but are replaced with other visualizations, such as, bar graph(s), stacked bar graph(s), table(s) and the like. In some embodiments the second region overlies the first or vice versa.

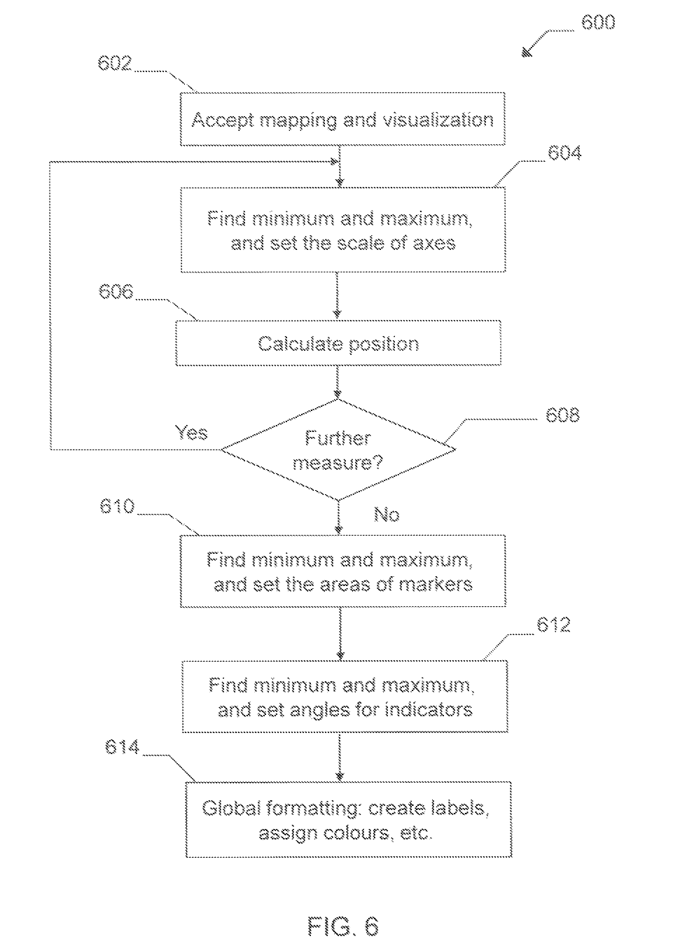

FIG. 6 is a flow diagram of a method for rendering visualizations in accordance with present teachings. Process 600 is an example of operations included in rendering a visualization. A visualization and a mapping of dimensions and measures to axes of a visualization are received at 602. In some embodiments the mapping includes associating a first dimension with a set of markers. In some embodiments the mapping includes associating a second dimension as a breakdown dimension with a set of indicators. In a loop over each measure mapped to a Cartesian axis, a search is made to find the minimum and maximum value of the measure. In the same operation 604 the scale is set for the measure. In various embodiments, creating the scale includes determining the minimum, maximum and graduation for the axis. The scale may be linear, logarithmic or trigonometric. In various embodiments the scale is specified by the mapping. At operation 606, the markers are positioned to the Cartesian axes. That is the spatial position of the markers is set with respect to one physical dimension for display. A check is made to determine if all the measures for the Cartesian axes are completed 608. If further measures are to be processed, 608—Yes, continue at operation 604 for the next measure associated with a Cartesian axes. If no measures remain, 608—No, operation 610 is next. The minimum and maximum values are found for the measure associated with the marker area. The area for each marker is set. In operation 612, the minimum and maximum values are found for the measure associated with the indicators embedded in the markers. Using this and applying the appropriate scale, the angle for each indicator is calculated. In various embodiments the values of the indicators are the angles of pie segments. At 614 any applicable general formatting like applying colour or assigning labels is done.

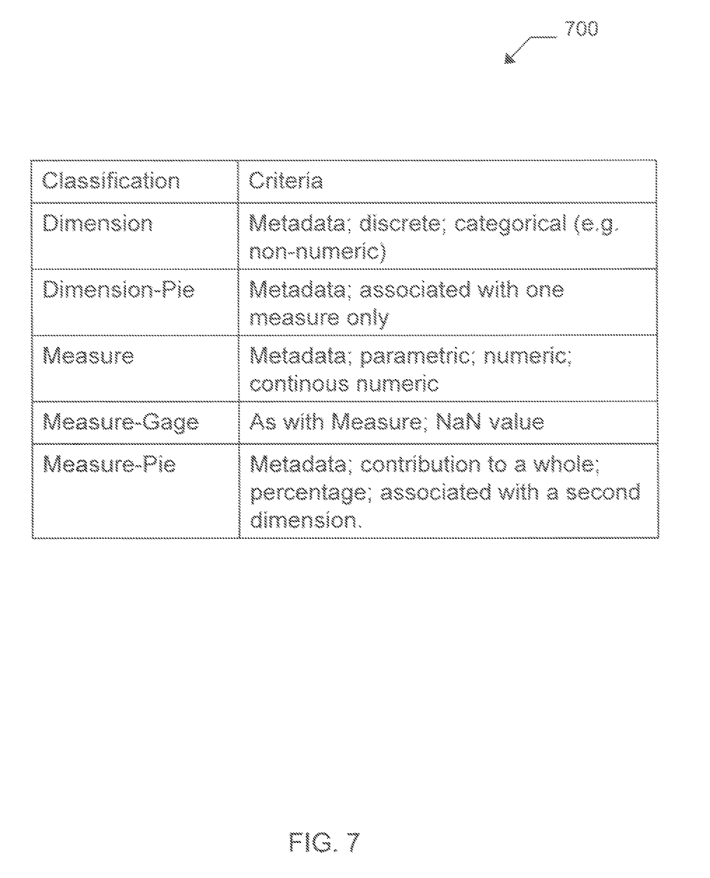

FIG. 7 is a table 700 showing criteria for preparing and rendering visualizations in accordance with various embodiments. Each row includes criteria to define a measure or a dimension in the first column. For example, see the first row where the dimension associated with a set of markers can be defined as a dimension because it is labeled a dimension by metadata, includes a discrete set of members, and/or is categorical data. The members of a dimension can admit an ordering, e.g., poor, fair, good. The third row corresponds to measures associated with measure axes, for example, associated with a Cartesian axis. The fourth row corresponds to a measure to be associated with the special case of a measure axis, a gauge type indicator within a set of markers. This measure may have one or more null, not a number (NaN) or like values for one or more members of its associated dimension. The breakdown dimension, corresponding to the second row, may be identified because it has only one associated measure. The measure associated with the breakdown dimension can be identified because it is associated with the breakdown dimension and/or its values are an expression of a portion of a whole.

Present teachings include various examples of computer implemented methods. The methods may be implemented by a computer system executing computer readable instructions. An example of a method includes displaying a data set within a graph. The graph comprising a set of markers arranged with respect to a first axis and a second axis. The set of markers are: associated with a dimension in the data set, and arranged with respect to the first axis according to values associated with a first measure. The set of markers are also: arranged with respect to the second axis according to a second measure in the data set, and scaled in size with respect to a third measure in the data set. Each maker is augmented with an indicator representing values of a fourth measure. The method includes receiving a user interaction selecting a subset of markers. The display is updated to show the subset of markers in uniform scale. The example method may be applied to the subset of markers when they number two, three, four or five. The example may further include receiving an additional user interaction brushing an additional subset of the markers. The display is update to increase the prominence of the additional subset. The example method may make use of gauges or pie charts as the set of indicators. For some methods the gauges each include a needle and a scale. For some methods the pie charts each include a plurality of pie segments. For some methods one or more indicators in the set of indicators encodes a null value.

Some embodiments of the invention may include the above-described methods being written as one or more software components. These components, and the functionality associated with each, may be used by client, server, distributed, or peer computer systems. These components may be written in a computer language corresponding to one or more programming languages, such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interlace level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable medium as instructions. The term “computer readable medium” should be taken to include a single medium or multiple media that stores one or more sets of instructions. The term “computer readable medium” should be taken to include any physical article that is capable of undergoing a set of physical changes to physically store, encode, or otherwise carry a set of instructions for execution by a computer system which causes the computer system to perform any of the methods or process operations described, represented, or illustrated herein. Examples of computer-readable media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, the present teachings may be implemented using Java, C++, or other object-oriented programming language and development tools. Another embodiment of the invention may be implemented in hard-wired circuitry in place of, or in combination with machine readable software instructions.

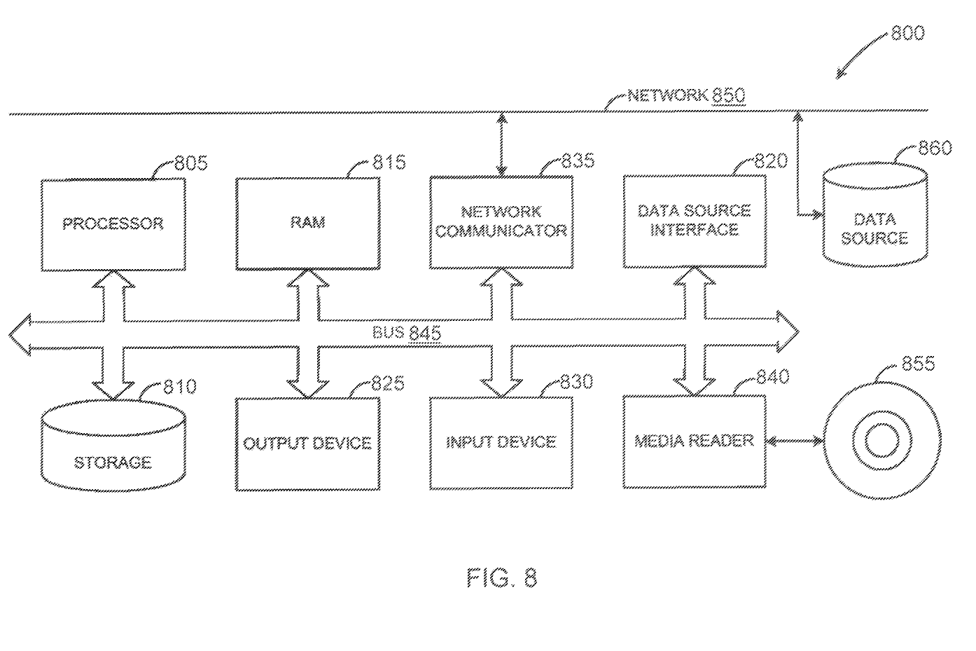

FIG. 8 is a block diagram of an exemplary computer system 800. The computer system 800 includes a processor 805 that executes software instructions or code stored on a computer readable medium 855 to perform the above-illustrated methods of the invention. The computer system 800 includes a media reader 840 to read the instructions from the computer readable medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800, to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be access via one or more abstraction layers implemented in hardware or software. For example, the data source 860 may be accessed through network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as. Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

The above descriptions and illustrations of embodiments of the invention. including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method, comprising:
receiving data including a dimension, a set of measures including a first measure, a second measure, and a third measure;
associating:
the dimension with a set of markers,
the first measure with a first axis,
the second measure with the area of the markers, and
the third measure with a set of indicators where indicators are embedded in
a plurality of the set of markers; and
displaying the set of markers with respect to the first axis in a graph.

2. The method of claim 1, further comprising detecting the dimension and the set of measures in the data.

3. The method of claim 1, further comprising:
receiving a fourth measure in the data; and
associating the fourth measure with a second axis.

4. The method of claim 1, further comprising associating the dimension with a second axis to encode redundancy in the graph.

5. The method of claim 1, wherein the set of indicators comprise pairs of needles and scales.

6. The method of claim 1, wherein the set of indicators comprise a plurality of pie segments.

7. The method of claim 1, further comprising:
returning a plurality mappings of the data to the axes of the graph; and
receiving a selection of a mapping from the plurality of mappings.

8. The method of claim 1, wherein an indicator in the set of indicators is null.

9. A computer implemented method, comprising:
displaying a data set within a graph comprising a set of markers arranged with respect to a first axis and a second axis, wherein the set of markers are:
associated with a dimension in the data set,
arranged with respect to the first axis according to values associated with a first measure,
arranged with respect to the second axis according to a second measure in the data,
scaled in size with respect to a third measure in the data set, and
each augmented with an indicator representing values of a fourth measure;
receiving a user interaction selecting a subset of markers; and
updating the display to show the subset of markers in uniform scale.

10. The method of claim 9, further comprising:
receiving an additional user interaction brushing an additional subset of the markers; and
updating the display to increase the prominence of the additional subset.

11. A computer readable medium comprising computer readable instructions, which, when executed by a computer, cause the computer to perform a method, the method comprising:
receiving data including a dimension, a set of measures including a first measure, a second measure, and a third measure;
associating:
the dimension with a set of markers,
the first measure with a first axis,
the second measure with the area of the markers, and
the third measure with a set of indicators where indicators are embedded in
a plurality of the set of markers; and
returning the graph.

12. The computer readable medium of claim 11, further comprising displaying the graph.

13. The computer readable medium of claim 11, further comprising detecting the dimension and the set of measures in the data.

14. The computer readable medium of claim 13, wherein detecting the dimension and the set of measures in the data includes processing metadata associated with the data.

15. The computer readable medium of claim 11, further comprising:
receiving a fourth measure in the data; and
associating the fourth measure with a second axis.

16. The computer readable medium of claim 11, further comprising associating the dimension with a second axis to encode redundancy in the graph.

17. The computer readable medium of claim 11, wherein the set of indicators comprise pairs of needles and scales.

18. The computer readable medium of claim 11, wherein the set of indicators comprise a plurality of pie segments.

19. The computer readable medium of claim 11, further comprising:
receiving a user interaction selecting a subset of markers; and
updating the display to show the subset of markers in uniform scale.

20. The computer readable medium of claim 11 wherein an indicator in the set of indicators encodes a null value.
